(19) United States
(12) Patent Application Publication
(10) Pub. No.: US 2012/0105246 A1
(43) Pub. Date: May 3, 2012

(54) CONTACTLESS UNDERWATER COMMUNICATION DEVICE

(75) Inventors: Daniel White Sexton, Niskayuna, NY (US); Amin Radi, Niskayuna, NY (US); John Thomas Garrity, Ballston Lake, NY (US)

(73) Assignee: GENERAL ELECTRIC COMPANY, Schenectady, NY (US)

(21) Appl. No.: 12/915,560

(22) Filed: Oct. 29, 2010

(51) Int. Cl. H04B 13/02

(52) U.S. Cl. 340/850

(57) ABSTRACT

This invention provides, inter alia, communication devices for contactless underwater data transmission and reception. In one embodiment the present invention provides a transmitting device comprising (a) a water-tight housing; (b) a radiative element disposed outside of the housing, said radiative element comprising at least two antennae, wherein the radiative element is configured to propagate an electric field signal through water; and (c) a communications section disposed within the housing, said communications section being coupled to said radiative element, said communications section comprising at least one transmitter, wherein the communications section is configured to transmit digitally modulated data as an electric field signal propagated by the radiative element. Also provided are similarly constituted receiving devices, transceiving devices, systems containing such devices and methods of using such devices and systems.

### BACKGROUND

This invention relates generally to the field of underwater communication. In particular, the invention relates to an underwater communication device. The invention also relates to a method for underwater communication.

There is a growing demand for reliable subsurface communication devices capable of retrieving data from data-gathering installations located in deep water or other subsurface locations where the use of physical data transmission cables is impractical. Known subsea communication devices include remotely operated vehicles (ROV), autonomous underwater vehicles (AUV) and manned submersibles. There is current interest in monitoring subsurface sea conditions such as temperature, current profiles, and seismic activity. Subsea communication devices are also needed to monitor underwater equipment including subsea risers and underwater piping systems. Robust methods of undersea communication have become an essential component of a wide variety of human subsea activities, and further improvements are desired.

Commonly used underwater wireless communication systems include acoustic communications systems, optical communications systems, and systems employing low frequency electromagnetic-radio frequency signal transmission and reception. Each of these systems has advantages and limitations. Acoustic systems are versatile and widely used. For example, acoustic modems operating in the range of 10-27 kilohertz can be used for subsea data transmission. In shallow water, however, the use of acoustic techniques can be interfered with by background noise, for example, noise due to wave action or boat engines. The slow speed of acoustic energy propagation in water (about 1500 meters per second), limits data transmission rates using acoustic subsea communications systems. Acoustic signals generated by acoustic subsea communication systems are known to suffer reflections from the surface and seabed resulting in multi-path propagation of the signal. As a result, related signals may arrive at a receiver at substantially different times and result in an complex data stream.

Optical systems can provide higher data transmission rates than acoustic systems; however, optical systems are subject to signal losses due to light scattering from particulates present in seawater. In addition, ambient light may interfere with signal reception. Optical systems are typically limited to data transmission over distances on the order of a few meters.

Electromagnetic signals are rapidly attenuated in water due to the partially electrically conductive nature of water. Seawater is more conductive than fresh water and as a result produces greater attenuation of an electromagnetic signal than does fresh water. Although electromagnetic radiation may be propagated through seawater, the relatively high conductivity of seawater tends to attenuate the electric field component of an electromagnetic wave being propagated through seawater. Water has a magnetic permeability close to that of free space so that a purely magnetic field is relatively unaffected by water. However, because the energy contained in electromagnetic radiation continually cycles between the magnetic and electric field components, a signal comprised of an electromagnetic radiation passing through water tends to be attenuated due to conduction losses, as a function of the distance traveled by the signal through the water.

Thus, despite the impressive technical achievements made to date in the field of underwater communication, further improvements are needed, especially in the field of contactless underwater communication at high data transmission rates. This disclosure provides solutions to a number of long-standing problems in underwater communication.

### BRIEF DESCRIPTION

In one embodiment, the present invention provides a communication device, comprising (a) a water-tight housing; (b) a radiative element disposed outside of the housing, said radiative element comprising at least two antennae, wherein the radiative element is configured to propagate an electric field signal through water; and (c) a communications section disposed within the housing, said communications section being coupled to said radiative element, said communications section comprising at least one transmitter, wherein the communications section is configured to transmit digitally modulated data as an electric field signal propagated by the radiative element.

In another embodiment, the present invention provides a communication device comprising (a) a water-tight housing; (b) a receptive element disposed outside of the housing, said receptive element comprising at least two antennae, wherein the receptive element is configured to detect an electric field signal being propagated through water; and (c) a communications section disposed within the housing, said communications section being coupled to said receptive element, said communications section comprising at least one receiver, wherein the communications section is configured to receive and demodulate digitally modulated data carried by an electric field signal sensed by the receptive element.

In yet another embodiment, the present invention provides a communication device comprising (a) a water-tight housing; (b) a radiative element disposed outside of the housing, said radiative element comprising at least two antennae, wherein the radiative element is configured to propagate an electric field signal through water and detect an electric field signal being propagated through water; and (c) a communications section disposed within the housing, said communications section being coupled to said radiative element, said communications section comprising at least one transmitter and at least one receiver, wherein the communications section is configured to transmit digitally modulated data as an electric field signal propagated by the radiative element and to receive and demodulate digitally modulated data carried by an electric field signal sensed by the radiative element.

In yet another embodiment, the present invention provides a method of underwater communication, comprising (i) bringing to within a signal contact distance a first communication device and a second communication device; (ii) propagating an electric field signal from the first communication device through a mass of water separating the first communication device from the second communication device; and (iii) receiving said electric field signal by the second communication device; wherein the first communication device comprises a water-tight housing; a radiative element disposed outside of the housing, said radiative element comprising at least two antennae, wherein the radiative element is configured to propagate an electric field signal through water; and a communications section disposed within the housing, said communications section being coupled to said radiative element, said communications section comprising at least one transmitter, wherein the communications section is configured to transmit digitally modulated data as an electric field signal propagated by the radiative element; and wherein the second communication device comprises a water-tight housing; a receptive element disposed outside of the housing, said receptive element comprising at least two antennae, wherein the receptive element is configured to detect an electric field signal through water; a communications section disposed within the housing, said communications section being coupled to said receptive element, said communications section comprising at least one receiver, wherein the communications section is configured to receive and demodulate digitally modulated data carried by an electric field signal sensed by the receptive element.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a communication device in accordance with one or more embodiments of the present invention;

FIG. 2 illustrates a communication device in accordance with one or more embodiments of the present invention;

FIG. 3 illustrates a communication device in accordance with one or more embodiments of the present invention;

FIG. 4 illustrates a predicted electric field based on Maxwell's electric current wave equation in accordance with certain embodiments of the present invention; and

FIG. 5 illustrates an amplitude versus frequency spectrum illustrating the successful transmission and reception of an electric field signal in accordance with one or more embodiments of the present invention.

### DETAILED DESCRIPTION

The present invention provides devices useful for the high speed transmission and reception of data by means of an electric field signal. The devices provided by the present invention are particularly well suited for use in underwater environments under circumstances where direct physical contact between a transmitting device and a receiving device is not practical. In one embodiment, the present invention provides a communication device which is a transmitting device. In an alternate embodiment, the present invention provides a communication device which is a receiving device. In yet another embodiment, the present invention provides a communication device which can function both as a transmitting device and a receiving device. A communication device capable of functioning both as a transmitting device and a receiving device may at times herein be referred to as a transceiving device.

As noted, in one embodiment, the present invention provides a communication device which is a transmitting device comprising a water-tight housing and a radiative element disposed outside of the housing. The radiative element comprises at least two antennae, a portion of each of which is disposed within the water-tight housing and a portion of each of which is disposed outside of the water-tight housing. The radiative element is configured to propagate an electric field signal through water and is coupled to a communications section disposed within the water-tight housing. The communications section comprises at least one transmitter but may comprise other components as well, such as a power source, for example a battery. The communications section is configured to transmit digitally modulated data as an electric field signal propagated by the radiative element.

In embodiments in which the communication device can function as a transmitting device, the communications section is configured for digital modulation of data. A wide variety of digital modulation techniques are known and may be used in accordance with one or more aspects of the present invention. Suitable modulation techniques include direct sequence spread spectrum (DSSS) digital modulation, orthogonal frequency division modulation (OFDM) digital modulation, frequency hopping spread spectrum (FHSS) digital modulation, quadrature phase shift key (QPSK) digital modulation, quadrature amplitude (QAM) digital modulation, binary phase shift key (BPSK) digital modulation, and combinations thereof, for example a combination of the DSSS and OFDM digital modulation techniques. Digital modulation of data can be carried out using a waveform generator, for example using any of a number of commercially available waveform generators known to those of ordinary skill in the art.

Other components of a communications section of a communication device configured to act as a transmitting device may include digital to analog converters (DAC), filters, power drivers, associated connectors, and power sources. In one embodiment, a communication device provided by the present invention comprises a power source battery, a waveform generator, a high speed digital to analog converter, a smoothing filter and a power driver coupled together such that the digital output of the waveform generator is provided as input to the digital to analog converter the output of which is processed by the smoothing filter connected to a power driver. The power driver is coupled to the radiative element which is configured to propagate an electric field signal through water. In one embodiment, the communications section configured to act as a transmitting device comprises a signal processing element, a filter element, a converter, and a power driver.

In various embodiments, the electric field signal is a variable electric field set up by the power driver and the antennae of the radiative element and may incorporate digitally modulated data. In one embodiment, the electric field signal is characterized by a frequency in a range from about 1 kilohertz to about 100 megahertz and an intensity in a range from about 1 micro volt per meter to about 100 volts per meter. In an alternate embodiment, the electric field signal has a frequency in a range of from about 1.1 kilohertz to about 10 megahertz. In yet another embodiment, the electric field signal has a frequency in a range of from about 1.5 kilohertz to about 5 megahertz.

As noted, in one embodiment, the electric field has an intensity in a range of from about 1 micro volt per meter to about 100 volts per meter. An advantage associated with working in this intensity range is that it requires relatively low transmitter power and yet be effective over short signal contact distances (The term signal contact distance is defined below). In various embodiments, those of ordinary skill in the art will appreciate that higher power (more field strength) may be required as the signal contact distance increases. In one embodiment, the electric field signal has an intensity of from about 10 nano-volts per meter to about 10 volts per meter.

Because the electric field signal generated by the communications section and propagated by the radiative element is purely electrical in its genesis, it is rapidly attenuated in a conductive medium such as salt water. As such, in various embodiments of the present invention, the contactless transmission of data from a transmitting device to a receiving device is carried out at relatively close range, typically in a range from a few millimeters to a few meters. In various embodiments, the contactless transmission of data from a transmitting device to a receiving device is carried out at a signal contact distance. As used herein the term “signal contact distance” represents a distance at which a data-carrying electric field signal may be transmitted from a transmitting device and received by a receiving device while maintaining a useful level of signal to noise. In one embodiment the signal contact distance is less than 100 meters. In another embodiment, the signal contact distance is less than 10 meters. In an alternate embodiment, the signal contact distance is less than 1 meter. In yet another embodiment, the signal contact distance is less than 0.5 meters.

The requirement during operation of relatively close proximity between a transmitting device of the present invention and a receiving device of the present invention is offset by the relatively high rates of data transmission which may be achieved when compared to conventional underwater communications techniques. In one embodiment, the present invention provides a method of underwater communication wherein the data transmission rate between a transmitting device of the present invention and a receiving device of the present invention is at least 100 kilobits per second. In an alternate embodiment, the data transmission rate is in a range from about 10 kilobits (kbps) per second to about 100 megabits (Mbps) per second.

As noted, the electric field signal is a variable electric field and may incorporate data in various components of the electric field, such as the electric field frequency, electric field phase, and the electric field amplitude. Those of ordinary skill in the art will appreciate the important distinction drawn between communication devices and methods of the present invention which rely upon an electric field signal and conventional contactless underwater communications schemes employing electromagnetic energy, such as radio waves.

As noted, in one embodiment the present invention provides a communication device which is a receiving device comprising a water-tight housing and a receptive element disposed outside of the housing. The receptive element comprises at least two antennae, a portion of each of which is disposed within the water-tight housing and a portion of each of which is disposed outside of the water-tight housing. The receptive element is configured to detect an electric field signal through water and is coupled to a communications section disposed within the water-tight housing. The communications section comprises at least one receiver but may comprise other components as well, such as a power source, for example a battery, or a data storage module. In one embodiment the communications section is configured to receive and demodulate digitally modulated data carried by an electric field signal sensed by the receptive element.

In various embodiments, the communications section of a receiving device comprises an amplifier coupled to the receptive element, the antennae of which are configured to sense an electric field signal being propagated through water. The communications section may be configured such that the output of the amplifier is directed to a filter, the output of which is directed to an analog to digital converter, the output of which is directed to a waveform interface board, the output of which is directed to a data demodulation and data storage unit. Thus, in one embodiment the present invention provides a communication device which is a receiving device comprising a communications section comprising an amplifier, a filter, an analog to digital converter, a waveform interface board, and associated connectors. As will be appreciated by those of ordinary skill in the art such communications section components are well known articles of commerce. In one embodiment, the communications section of a receiving device provided by the present invention has a dynamic range of from about 10 nano-volts per meter to about 10 volts per meter.

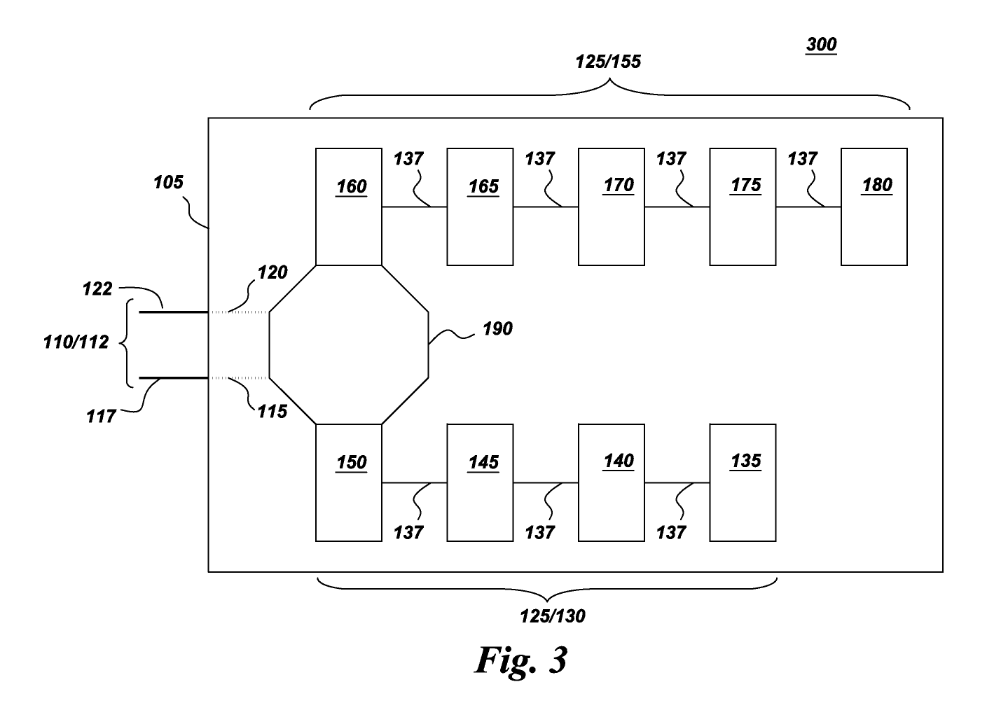

As noted, in one embodiment the communication device is a transceiving device having a first communications section comprising a transmitter coupled to a radiative element and second communications section comprising a receiver coupled to a receptive element. Thus, in one embodiment the present invention provides a communication device comprising a water-tight housing; a radiative element comprising at least two antennae, wherein the radiative element is configured to propagate an electric field signal through water; a first communications section disposed within the housing, said communications section being coupled to said radiative element, said communications section comprising at least one transmitter, wherein the communications section is configured to transmit digitally modulated data as an electric field signal propagated by the radiative element; a receptive element disposed outside of the housing, said receptive element comprising at least two antennae, wherein the receptive element is configured to detect an electric field signal being propagated through water; and a second communications section disposed within the housing, said communications section being coupled to said receptive element, said communications section comprising at least one receiver, wherein the communications section is configured to receive and demodulate digitally modulated data carried by an electric field signal sensed by the receptive element. In one embodiment the transceiving device comprises a single set of antennae which function both as the radiative element and the receptive element. (See for example, FIG. 3 herein). In one embodiment, the first and second communications sections are combined within a single communications section which functions as a transceiver. In such an embodiment, the communications section is configured to digitally modulate digital data, and to demodulate digitally modulated data.

As noted, the radiative element and receptive element of the communication devices provided by the present invention are configured to propagate an electric field signal through water in the case of the radiative element, or to detect an electric field signal being propagated through water in the case of the receptive element. The electric field signal may be said to be propagated from the radiative element of the transmitting device to the receptive element of the receiving device through an intervening mass of water separating the two devices. In various embodiments, the water though which the electric field signal is propagated has an average conductivity in a range from about 3 Siemens per meter to about 7 Siemens per meter.

Both the radiative element and the receptive element comprise at least two antennae comprising an electrically conducting material or a semi-conducting material. In one embodiment, the present invention provides a communication device comprising a radiative element comprising at least two antennae comprising copper metal. Under such circumstances, the radiative element is said to comprise an electrically conducting material (or simply a “conducting material”), copper. In one embodiment, the present invention provides a communication device comprising a receptive element comprising at least two antennae comprising copper metal. Under such circumstances, the receptive element is said to comprise an electrically conducting material (or simply a “conducting material”), copper.

As noted, in various embodiments, the communication device provided by the present invention may comprise antennae comprising a conducting material, a semi-conducting material, or a combination thereof. In one embodiment the antennae comprise a conducting material selected from the group consisting of copper, silver, gold, aluminum, and bronze. In one embodiment, the present invention provides a communication device comprising bronze antennae. In an alternate embodiment, the present invention provides a communication device comprising copper antennae.

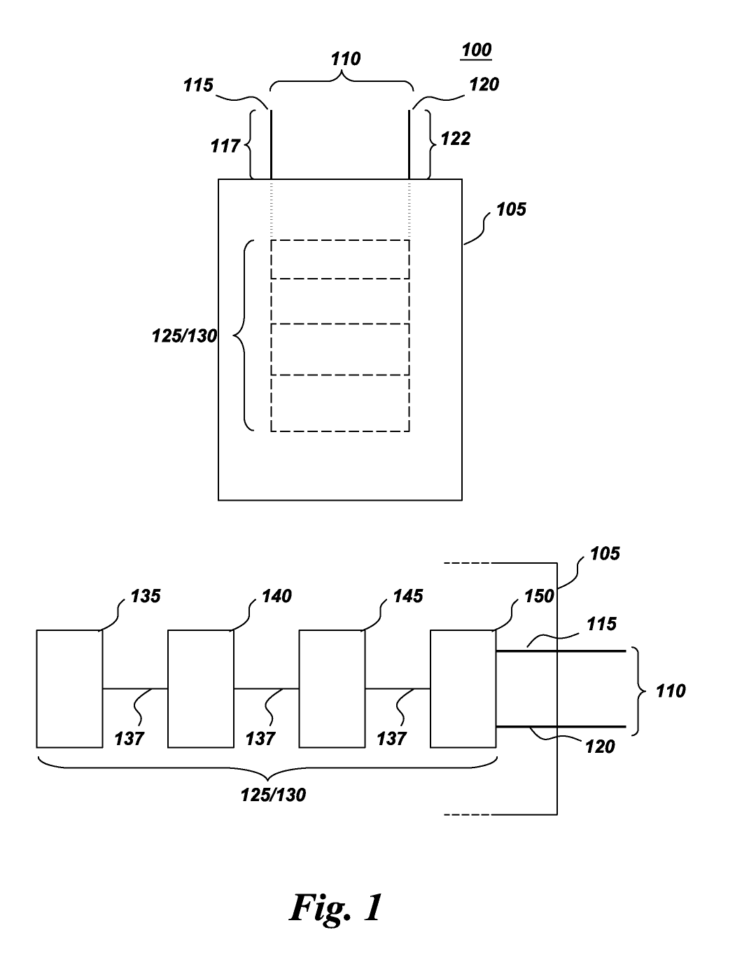

Referring to FIG. 1, the figure illustrates a communication device 100 according to an embodiment of the invention and an exploded view of the same device which is configured as a transmitter configured to transmit digitally modulated data as an electric field signal propagated by a radiative element. The device 100 comprises a water-tight housing 105 and a radiative element 110. In the embodiment shown, the radiative element 110 comprises two antennae 115 and 120 a portion of each of which (117 and 122) is disposed outside of the water-tight housing. The portions of the antennae disposed outside of housing 105 (117 and 122) are designed for direct and/or indirect contact with water. Each antenna 115 and 120 extends into the interior of the housing and is coupled to a communications section 125 which is configured as a transmitter 130. Transmitter 130 comprises a waveform generator 135 which functions to digitally modulate the data to be transmitted. As noted, a wide variety of digital modulation techniques are known to those of ordinary skill in the art. Waveform generator 135 is coupled via connector 137 to a digital to analog converter 140 which in turn is connected to a filter 145 and a power driver 150 which is configured to propagate an electric field signal through water. Various connectors 137 are known to those of ordinary skill in the art, for example SMA and BNC connectors. Power may be supplied to the communication device from an on-board battery (not shown in figure) or another source of electrical power such as an umbilical (not shown in figure).

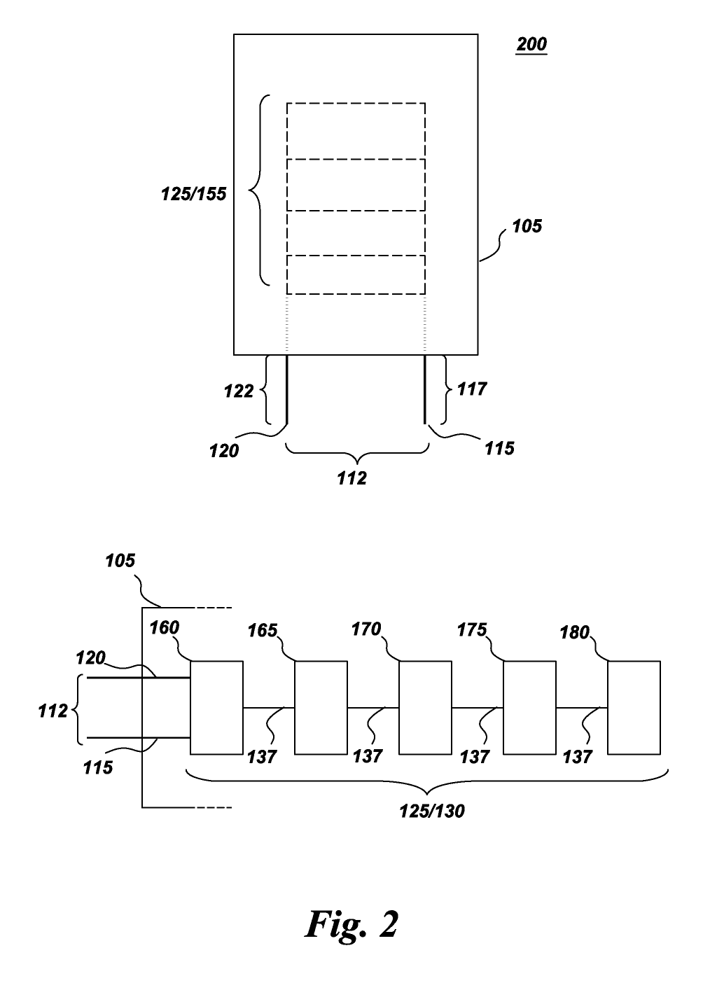

Referring to FIG. 2, the figure illustrates a communication device 200 according to an embodiment of the invention and an exploded view of the same device. Communication device 200 is a receiving device configured to detect and store digitally modulated data which has been transmitted as an electric field signal propagated through water. The device 200 comprises a water-tight housing 105 and a receptive element 112. In the embodiment shown in FIG. 2, the receptive element 112 comprises two antennae 115 and 120 a portion of each of which (117 and 122) is disposed outside of the water-tight housing. The portions of the antennae disposed outside of housing 105 (117 and 122) are designed for direct and/or indirect contact with water. Each antenna 115 and 120 extends into the interior of the housing and is coupled to a communications section 125 which is configured as a receiver 155. Receiver 155 comprises an amplifier 160 coupled via connectors 137 to filter 165, analog to digital converter 170, waveform interface board 175 and data demodulator and storage unit 180. Power may be supplied to the communication device 200 from an on-board battery (not shown in figure) or another source of electrical power such as an umbilical (not shown in figure). In one embodiment, the communication device 200 is configured to function as a waveform sampler capable of sampling data at 40 megahertz.

Referring to FIG. 3, the figure illustrates a communication device 300 according to an embodiment of the invention and an exploded view of the same device. Communication device 300 is configured as a transceiving device configured both to transmit digitally modulated data as an electric field signal through water and to detect an electric field signal being propagated through water. Communication device 300 comprises a water-tight housing 105 and a pair of antennae 115 and 120 which function both as a radiative element 110 and a receptive element 112. Communication device 300 comprises a first communications section 125 which is a transmitter 130, and a second communications section 125 which is a receiver 155. Transmitter 130 is essentially the same as shown in FIG. 1. Receiver 155 is essentially the same as shown in FIG. 2. In the illustrated embodiment, communication device 300, also at times herein referred to as a transceiving device, comprises a switching module 190 which is configured to connect alternately communications sections 125/130 and 125/155 to radiative/receptive element 110/112. Those of ordinary skill in the art will appreciate that such switching modules are readily available articles of commerce.

With respect to each of the embodiments shown in FIGS. 1-3 and other embodiments provided by the present invention, the antennae which comprise the radiative element and/or the receptive element may be configured such that the lengths of the portion of antenna disposed outside of the water-tight housing may be varied as required. In one embodiment, the length of the antennae projecting outside of the water-tight housing may be adjusted to match the antenna impedance to the transmitter impedance based on the conductivity of water, for example seawater. The portions of the antennae of a radiative element or a receptive element disposed outside of the water-tight housing may be configured such that a first antenna portion is parallel to a second antenna portion, such that a first antenna portion diverges away from a second antenna portion, or such that a first antenna portion converges toward a second antenna portion. Such portions may be of equal length or such portions may be of unequal length. In certain embodiments, the bias of the antennae (parallel, diverging, converging) may be varied during operation in order to optimize signal transmission and reception.

The housing may be formed of any suitable material (or combinations of materials) that is water impermeable and non-conducting, for example glass. In various embodiments, the material used to form the housing is corrosion resistant. In one embodiment, the housing is made of a transparent polymeric material such as commercially available polycarbonate. In an alternate embodiment, the housing is made of a non-transparent polymeric material such as various grades of commercially available polyvinyl chloride (PVC). In one embodiment, the housing is made of commercially available PVC piping.

In another embodiment, the present invention provides a communication system comprising at least two communication devices of the present invention; a first (transmitting) device comprising a radiative element comprising at least two antennae configured to propagate an electric field through water, and a second (receiving) device comprising a receptive element comprising at least two antennae configured to detect an electric field signal being propagated through water.

In one embodiment, the present invention provides a communication system comprising one or more transceiving devices comprising (a) a water-tight housing; (b) a radiative element disposed outside of the housing, said radiative element comprising at least two antennae, wherein the radiative element is configured alternately to propagate an electric field signal through water and detect an electric field signal being propagated through water; and (c) a communications section disposed within the housing, said communications section being coupled to said radiative element, said communications section comprising at least one transmitter and at least one receiver, wherein the communications section is configured to transmit digitally modulated data as an electric field signal propagated by the radiative element and to receive and demodulate digitally modulated data carried by an electric field signal sensed by the radiative element.

In one embodiment, the at least two devices are disposed at a distance of less than about 100 meters from each other. In an alternate embodiment, the at least two devices are disposed at a distance of less than about 10 meters from each other. In yet another embodiment, the at least two devices are disposed at a distance of less than about 1 meter from each other. In yet still another embodiment, the at least two devices are separated by a distance in a range from about 0.01 meter to about 1 meter.

In one embodiment, the communication system provided by the present invention may be employed for short-range communication between a remotely operated vehicle (ROV) and an underwater asset. Typically data exchange between an underwater asset and an ROV will be carried out at a distance of less than 100 meters. In one embodiment, the communication system provided by the present invention may be employed for very short range, very high-speed data transmission, for example the transmission of data being gathered in real time and transmitted across a short signal contact distance (e.g. a few millimeters).

In still yet another embodiment, a method of communicating underwater is provided. The method comprises bringing to within a signal contact distance a first communication device and a second communication device and propagating an electric field signal from the first communication device through a mass of water separating the first communication device from the second communication device. The second communication device receives the electric field signal. The first communication device comprises a water-tight housing and a radiative element disposed outside of the housing. The radiative element comprises at least two antennae configured to propagate an electric field signal through water and a communications section disposed within the housing. The communications section of the first communication device is coupled to the radiative element (the antennae). The communications section of the first communication device comprises at least one transmitter configured to transmit digitally modulated data as an electric field signal propagated by the radiative element. The second communication device comprises a water-tight housing and a receptive element disposed outside of the housing. The receptive element of the second communication device comprises at least two antennae configured to detect an electric field signal being propagated through water. The second communication device comprises a communications section disposed within the housing. The communications section is coupled to the receptive element (the antennae). The communications section of the second communication device comprises at least one receiver and is configured to receive and demodulate digitally modulated data carried by an electric field signal sensed by the radiative element.

In one embodiment, the present invention may be used to monitor the integrity of flange joints in a subsea riser. Thus, a sensor is disposed proximate to a gap between adjacent flanges on a subsea riser and monitors the gap between the riser sections for any change relative to a reference specification. Data from the sensor is provided to a first communication device provided by the present invention. The first communication device transmits digitally modulated data as an electric field signal to a second communication device of the present invention through an intervening mass of water separating the two devices. In one embodiment, the first communication device digitally modulates the sensor data. In an alternate embodiment, the sensor itself digitally modulates the sensor data. In yet another embodiment, the sensor is integrated into the first communication device. In one embodiment, the first communication device is attached the subsea riser at a location such that the device is configured to sense a signal between sensors disposed within a gap between adjacent flanges on the riser. The first communication device detects the sensor signal, digitally modulates the sensor signal, and transmits the digitally modulated signal as an electric field signal to a second communication device provided by the present invention. In one embodiment the first communication device is hard-wired to at least one of the sensors. In an alternate embodiment, the communication of the sensor signal from at least one of the sensors to the first communication device is wireless.

In yet another embodiment, the present invention may be used to monitor an undersea pipeline. Thus, a first communication device of the invention proximate to the undersea pipeline is configured to sense one or more characteristics of the pipeline, for example internal temperature, external temperature, internal pressure, and fluid flow rate through the pipeline. The first communication device senses a signal correlating with one or more of such characteristics and converts the signal into digitally modulated data which is propagated into the surrounding seawater as an electric field signal. A second communication device of the invention, for example an ROV, is brought to within a suitable signal contact distance of the first communication device. The second communication detects, demodulates and stores the electric field signal transmitted by the first communication device.

Although specific examples have been provided herein which include subsurface monitoring of subsea pipelines and undersea risers used in oil production, the present invention may be used to monitor a host of undersea assets including subsea cables and subsea seismic monitors.

### EXPERIMENTAL PART

### Experiment 1

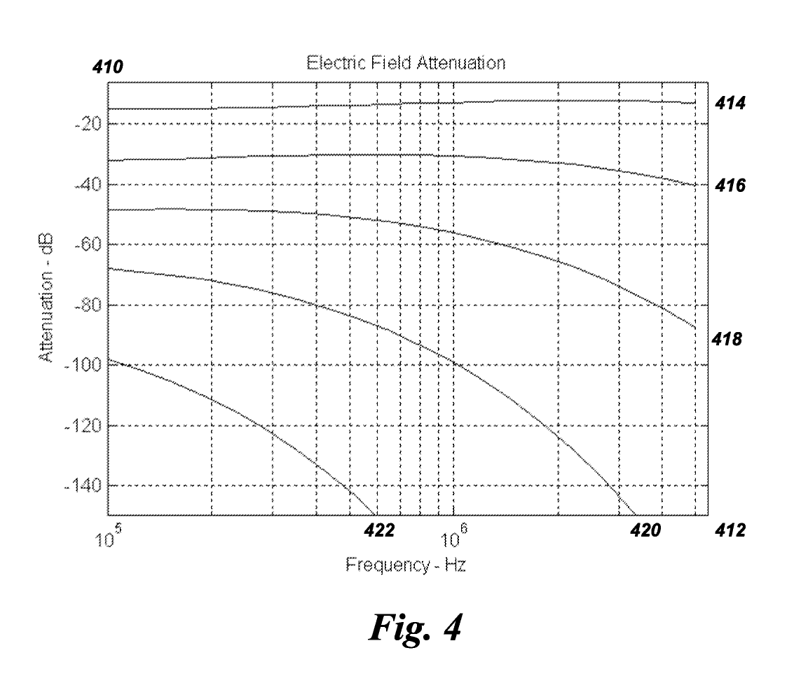

A preliminary investigation was carried out in an effort to model electric field signal attenuation in water as a function of the signal frequency and the distance between a transmitting device and a corresponding receiving device. FIG. 4. presents the calculated electric field attenuation for a model system comprising an electric field signal transmitting device and electric field signal receiving device immersed in water, and is based on Maxwell's electric current wave equation. The Y-axis 410 represents the calculated magnitude of the electric field attenuation in response to changing electric field signal frequency (X-axis 412). The distance between the communication devices was varied to obtain the family of frequency response curves shown: curve 414 (0.25 meters), curve 416 (0.5 meters), curve 418 (1 meter), curve 420 (2 meters), and curve 422 (4 meters). The calculated data indicate that a relatively steep loss in electric field signal strength (roll-off) occurs with increasing signal frequency at signal contact distances greater than about 0.5 meters. The practical effect of the results shown in FIG. 4 is that signal contact distances between the transmitting devices and the receiving devices provided by the present invention need to be relatively small to maintain high speed data transmission through water at practical transmitter power levels.

Next a set of tests was carried out in a controlled salt water test tank filled with ocean water having an average conductivity of about 4.8 Siemens per meter. A battery powered transmitting device comprising a communications section including a waveform generator (FPGA & Flash) SZ130-U00-K coupled to a high speed digital to analog converter coupled to a 6 pole BW (bandwidth) smoothing filter and 1A power driver (LT1210). The power driver was coupled to a pair of copper antennae. The communications section was enclosed in a water-tight housing composed of a PVC tube closed at each end. The water-tight housing was configured such that a portion of the copper antennae extended several inches beyond the outer surface of the same end of the PVC tube.

The transmitting device was placed in the salt water test tank such that the device floated on the surface with the antennae extending downward into the water. The portion of the antennae disposed outside of water-tight housing was in direct contact with the ocean water.

A receiving device was placed on a raft floating on the surface of the test tank at a controlled distance from the transmitting device. The receptive element of the receiving device comprised a par of aluminum antennae joined to a receiver contained within a water-tight housing constructed from a PVC tube and appropriate tube end-sealing components. The receiver comprised a gain selectable amplifier and an anti-aliasing filter, an analog to digital converter (ADC14L040) and a waveform interface board (WaveVison). The on-board receiver was linked via a fiber optic cable to an “on-shore” computer host configured to demodulate and store data transmitted from the transmitting device to the receiving device.

In a first test, the transmitting device was programmed to produce a test signal comprising 8 pilot tones of equal amplitude in a frequency range of from about 100 kilohertz to about 5 megahertz with a peak to peak output of about 1 volt. The test signal was transmitted by the transmitting device through the intervening mass of ocean water between the transmitting device antennae and the receiving device antennae. The test signal was detected by the receiving device and stored in the computer host.

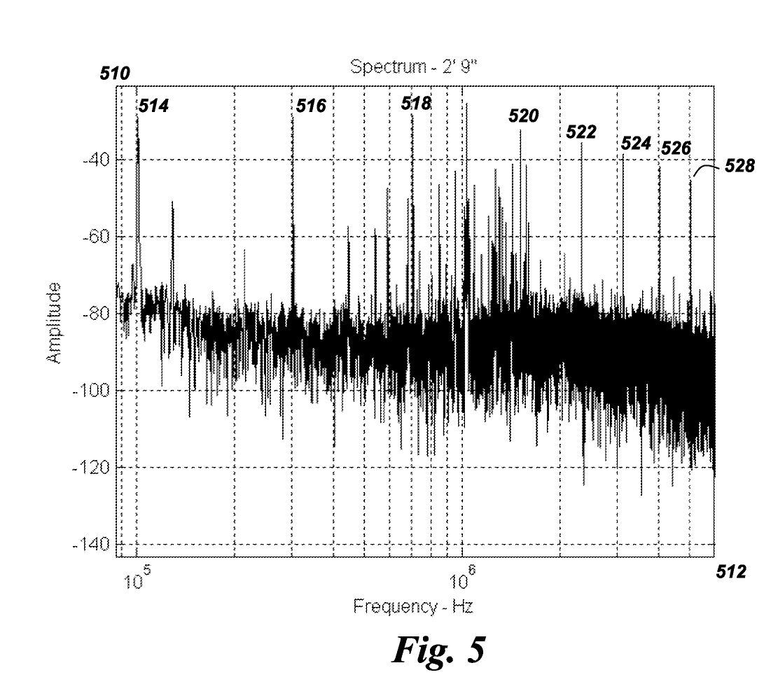

FIG. 5 represents an amplitude versus frequency spectrum collected by the receiving device where the transmitting device and the receiving device were separated by a distance of two feet nine inches. The spectrum plots signal amplitude (Y axis 510) versus frequency (X axis 512). Under these circumstances, a separation of two feet and nine inches represents a viable signal contact distance as all 8 tones are clearly discernable from noise. Thus, tones 514 (100 kilohertz), 516 (302 kilohertz), 518 (705 kilohertz), 520 (1.41 megahertz), 522 (2.32 megahertz), 524 (3.12 megahertz), 526 (4.03 megahertz), and 528 (5.04 megahertz) are clearly discernable across the entire frequency range tested.

Next the distance between the transmitting device and receiving device was increased to sixteen feet nine inches and the same test signal comprising 8 pilot tones of equal amplitude in a frequency range of from about 100 kilohertz to about 5 megahertz with a peak to peak output of about 1 volt was employed. Data collected by the receiving device was displayed and analyzed as a signal to noise versus frequency spectrum (not shown). At a distance of sixteen feet nine inches, only the tone at 100 kilohertz was clearly distinguishable from noise.

Next the distance between the transmitting device and the receiving device was varied between about twenty-one inches and about two hundred inches. The same test signal comprising 8 pilot tones of equal amplitude in a frequency range of from about 100 kilohertz to about 5 megahertz with a peak to peak output of about 1 volt was employed. At distances under about five feet, each of the 8 pilot tones was distinguishable from noise. However, at greater distances, the signal was at least partially obscured by the noise floor.

### Experiment 2

A transmitting device of the present invention configured as in Experiment 1 was entirely submerged in the test tank used for Experiment 1 at depths ranging from about 17 inches below the surface to about 183 inches below the surface while maintaining a more or less constant lateral distance from the receiving device at the surface. The receptive element of receiving device comprised two bronze electrodes extending downward below the surface of the water of the test tank.

The transmitting device was programmed to a transmit the 8 non-data carrying pilot tones used in Experiment 1, and in addition, 2 data carrying signals. The data carrying signals were created by direct sequence spread spectrum (DSSS) digital modulation of two pilot tones (Signal #1 a 50 KHz I-Q modulated 504 KHz pilot tone, and Signal #2 a 100 KHz I-Q modulated 1.91 MHz pilot tone) and transmitted together with the 8 non-data carrying pilot tones employed in Experiment 1 from the transmitting device to the receiving device. Results obtained showed that at a signal contact distance of about 15 inches, a data transmission rate of about 100 kilobits per second (kbps) was achieved for the first data carrying pilot tone (#1) with an symbol error rate (SER) of 0, and correspondingly a data transmission rate of about 200 kbps for the second data carrying pilot tone (#2) with an SER of 0. These high data transmission rates and low SERs were also achieved at a longer signal contact distance (28 inches). At yet still longer signal contact distances higher SER levels were encountered. Data for the two data carrying signals are gathered in Table 1 below. At each of the signal contact distances shown in Table 1 below, the 8 non-data carrying pilot tones were also clearly discernable.

TABLE 1

| | Signal Contact | Data Transmission | | |
|---|---|---|---|---|
| Signal | Distance | Rate | SER* | PN^{†} |
| #1 | 15 inches | 100 kbps | 0 | + |
| #2 | 15 inches | 200 kbps | 0 | + |
| #1 | 28 inches | 100 kbps | 0 | + |
| #2 | 28 inches | 200 kbps | 0 | + |
| #1 | 51 inches | 100 kbps | 0 | + |
| #2 | 51 inches | 200 kbps | 30.7% | + |
| #1 | 75 inches | 100 kbps | 25% | + |
| #2 | 75 inches | 200 kbps | 62% | + |

Signal #1 = 50 KHz modulated 504 KHz pilot tone;
Signal #2 = 100 KHz modulated 1.91 MHz pilot tone;
*SER = symbol error rate;
^{†}PN = pseudo number correlation: + indicates a strong correlation.

### Experiment 3

A transmitting device of the present invention configured as in Experiment 1 was submerged in the test tank used for Experiment 1 at a depth of about 1 meter. A receiving device configured as in Experiment 2 was likewise submerged in the test tank at a depth of 1 meter. The transmitting device was programmed to transmit the 8 non-data carrying pilot tones used in Experiments 1 and 2. The signal contact distances between the transmitting device and the receiving device were varied from about 16 inches to about 74 inches (16″, 26″, 50″, and 74″) at which distances each of the 8 pilot tones was clearly discernable from noise. At greater distances, (102″, 122″ and 146″) the pilot tones were still discernable but signal strength was erratic. It is believed that at these greater signal contact distances, signal strength may have been affected by the proximity of the radiative element and receptive element to the bottom of the test tank. It is noteworthy that such effects can be overcome by shortening the signal contact distance.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A communication device, comprising:
(a) a water-tight housing;
(b) a radiative element disposed outside of the housing, said radiative element comprising at least two antennae, wherein the radiative element is configured to propagate an electric field signal through water; and
(c) a communications section disposed within the housing, said communications section being coupled to said radiative element, said communications section comprising at least one transmitter, wherein the communications section is configured to transmit digitally modulated data as an electric field signal propagated by the radiative element.

2. The device of claim 1, wherein the radiative element comprises a conducting material, a semi-conducting material, or a combination thereof.

3. The device of claim 1, wherein the communications section is configured for digital modulation of digital data by direct sequence spread spectrum (DSSS) digital modulation, orthogonal frequency division modulation (OFDM) digital modulation, frequency hopping spread spectrum (FHSS) digital modulation, quadrature phase shift key (QPSK) digital modulation, quadrature amplitude (QAM) digital modulation, binary phase shift key (BPSK) digital modulation, or a combination thereof.

4. The device of claim 1, wherein the communications section comprises one or more of a waveform generator, a digital to analog converter, a filter, and a power driver.

5. A communication device, comprising:
(a) a water-tight housing;
(b) a receptive element disposed outside of the housing, said receptive element comprising at least two antennae, wherein the receptive element is configured to detect an electric field signal being propagated through water; and
(c) a communications section disposed within the housing, said communications section being coupled to said receptive element, said communications section comprising at least one receiver, wherein the communications section is configured to receive and demodulate digitally modulated data carried by an electric field signal sensed by the receptive element.

6. The device of claim 5, wherein the receptive element comprises a conducting material, a semi-conducting material, or a combination thereof.

7. The device of claim 5, wherein the communications section is configured demodulate digital data modulated by direct sequence spread spectrum (DSSS) digital modulation, orthogonal frequency division modulation (OFDM) digital modulation, frequency hopping spread spectrum (FHSS) digital modulation, quadrature phase shift key (QPSK) digital modulation, quadrature amplitude (QAM) digital modulation, binary phase shift key (BPSK) digital modulation, or a combination thereof.

8. The device of claim 5, wherein the communications section comprises one or more of a low noise amplifier, a filter, and analog to digital converter, a waveform interface board and a data demodulation and storage unit.

9. A communication device, comprising:
(a) a water-tight housing;
(b) a radiative element disposed outside of the housing, said radiative element comprising at least two antennae, wherein the radiative element is configured to propagate an electric field signal through water and detect an electric field signal being propagated through water; and
(c) a communications section disposed within the housing, said communications section being coupled to said radiative element, said communications section comprising at least one transmitter and at least one receiver, wherein the communications section is configured to transmit digitally modulated data as an electric field signal propagated by the radiative element and to receive and demodulate digitally modulated data carried by an electric field signal sensed by the radiative element.

10. The device of claim 9, wherein the radiative element comprises a pair of copper antennae.

11. The device of claim 9, wherein the communications section is configured to function in a transmitter mode and comprises one or more of a waveform generator, a waveform generator, a digital to analog converter, a filter, and a power driver.

12. The device of claim 9, wherein the communications section is configured to function in a receiver mode and comprises one or more of a low noise amplifier, a filter, and analog to digital converter, a waveform interface board and a data demodulation and storage unit.

13. The device of claim 9, wherein the communications section is configured to modulate and demodulate digital data modulated by direct sequence spread spectrum (DSSS) digital modulation, orthogonal frequency division modulation (OFDM) digital modulation, frequency hopping spread spectrum (FHSS) digital modulation, quadrature phase shift key (QPSK) digital modulation, quadrature amplitude (QAM) digital modulation, binary phase shift key (BPSK) digital modulation, or a combination thereof.

14. The device of claim 9, wherein the communications section is configured to modulate and demodulate digital data modulated by direct sequence spread spectrum (DSSS) digital modulation.

15. The device of claim 9, wherein the communications section is configured to modulate and demodulate digital data modulated by orthogonal frequency division modulation (OFDM) digital modulation.

16. A communication system comprising one or more devices of claim 9.

17. A method of underwater communication, comprising:
(i) bringing to within a signal contact distance a first communication device and a second communication device;
(ii) propagating an electric field signal from the first communication device through a mass of water separating the first communication device from the second communication device; and
(iii) receiving said electric field signal by the second communication device;
wherein the first communication device comprises a water-tight housing; a radiative element disposed outside of the housing, said radiative element comprising at least two antennae, wherein the radiative element is configured to propagate an electric field signal through water; and a communications section disposed within the housing, said communications section being coupled to said radiative element, said communications section comprising at least one transmitter, wherein the communications section is configured to transmit digitally modulated data as an electric field signal propagated by the radiative element; and
wherein the second communication device comprises a water-tight housing; a receptive element disposed outside of the housing, said receptive element comprising at least two antennae, wherein the receptive element is configured to detect an electric field signal being propagated through water; a communications section disposed within the housing, said communications section being coupled to said receptive element, said communications section comprising at least one receiver, wherein the communications section is configured to receive and demodulate digitally modulated data carried by an electric field signal sensed by the receptive element.

18. The method of claim 17, wherein the signal contact distance is less than about 1 meter.

19. The method of claim 17, wherein said propagating an electric field signal from the first communication through a mass of water separating the first communication device from the second communication device and said receiving said electric field signal by the second communication device is characterized by a data transmission rate of at least 100 kilobits per second.

20. The method of claim 17, wherein the electric field signal is characterized by a frequency in a range of from about 1 kilohertz to about 100 megahertz.

21. The method of claim 17, wherein the electric field signal is characterized by an intensity in a range of from about 1 micro volt per meter to about 100 volts per meter.

22. The method of claim 17, wherein the receiver of the second communication device has a dynamic range of from about 10 nano-volts per meter to about 10 volts per meter.

23. The method of claim 17, wherein said intervening mass of water has an average conductivity of from about 3 to about 7 Siemens per meter.

24. The method of claim 17, wherein the signal contact distance is less than 0.5 meter.

25. The method of claim 17, further comprising transmitting an electric field signal from the second communication device to the first communication device.
